(19) United States
(12) Patent Application Publication
(10) Pub. No.: US 2024/0009814 A1
(43) Pub. Date: Jan. 11, 2024

(54) HAND-HELD TOOL WITH SWIVEL JOINT ADAPTER AND FAIL-SAFE RELEASE MECHANISM

(71) Applicant: Stanley Winnard, Dallas, TX (US)

(72) Inventor: Stanley Winnard, Dallas, TX (US)

(21) Appl. No.: 18/472,619

(22) Filed: Sep. 22, 2023

Related U.S. Application Data
(63) Continuation of application No. 16/769,232, filed on Jun. 2, 2020.

(51) Int. Cl. B25B 23/00; F16C 11/04

(52) U.S. Cl. CPC B25B 23/0028; F16C 11/045; B25B 13/04

(57) ABSTRACT

A swivel joint adapter is for use between a tool handle and tool head such as a wrench head. The swivel joint adapter includes a tongue interposed between forked arms. The tongue and forked arms are able to be selectively swiveled upon simultaneous depression of two opposed release buttons. The release buttons have toothed-wall cylinders which lock with similar walls defined on apertures through the forked arms and tongue. Upon depression of the buttons, the toothed walls of the button disengage by lateral sliding movement from the toothed walls of the forked arms, thereby allowing swivelling of the joint adapter.

### CROSS-REFERENCE TO RELATED APPLICATIONS

This application is a United States Continuation application claiming priority to U.S. application Ser. No. 16/769,232, filed Jun. 2, 2020, which claims priority to International Application PCT/US2017/065176 filed Dec. 7, 2017.

### TECHNICAL FIELD

The disclosure relates in general to hand-tools having selectively adjustable parts, and more specifically to wrenches and hand-tools having hinged and swiveled joints with fail-safe engagement mechanisms therefore.

### BRIEF DESCRIPTION OF THE DRAWING

For a more complete understanding of the features and advantages of the present disclosure, reference is now made to the detailed description of the disclosure along with the accompanying figures in which:

FIG. 1 is a top view of a hand-operated tool, namely a wrench, having two swivel joint adapters on opposing ends of the wrench in accordance with aspects of the present disclosure.

FIG. 2 is an elevational view of the hand-operated tool of FIG. 1 in accordance with aspects of the present disclosure.

FIG. 3 is a detail view of a swivel joint adapter and ratchet head of the wrench of FIGS. 1-2.

FIG. 4 is an exploded, detail view of a swivel joint adapter of FIGS. 1-3.

FIG. 5 is an orthogonal view of a swivel joint adapter of FIGS. 1-4.

FIG. 6A is a cross-sectional view of a swivel joint according to aspects of the disclosure shown in a home or first position.

FIG. 6B is a cross-sectional view of the swivel joint seen in FIG. 6A shown in a depressed or second position.

FIG. 7 is a schematic top view of a hand-operated tool having multiple swivel joint adapters according to aspects of the disclosure.

### DETAILED DESCRIPTION OF SOME EMBODIMENTS OF THE DISCLOSURE

While the making and using of various embodiments of the present disclosure are discussed in detail below, it should be appreciated that the present disclosure provides many applicable concepts that can be embodied in a wide variety of contexts. The specific embodiments discussed herein are merely illustrative of specific ways to make and use the disclosure and do not delimit the scope of the invention.

The disclosure is for a hand-operated tool with at least one swivel joint adapter having a fail-safe, double-release mechanism for selectively unlocking the joint adapter and allowing the relative swivel motion. The swivel joint adapter can be connected to a straight or contoured shaft, handle, bar, or lever at one or both ends. For example, the hand-operated tool can be a wrench, ratchet, pry bar, or other hand-operated tool.

The swivel joint adapter is permanently or removable attached to a tool shaft and an adjacent tool part, such as a tool head or another shaft. The swivel adapter allows selective relative motion between the tool and adjacent head or shaft. For example, a pivoting wrench head can be connected to the tool shaft by a swivel adapter, thereby allowing movement of the wrench head in multiple planes to various positions. In another example, multiple tool shafts can be daisy-chained together by connecting swivel joint adapters to create a segmented tool with numerous lockable joints. In a similar manner numerous swivel adaptors can be connected end to end to make a segmented tool that has numerous lockable swivel points.

As an example, the present disclosure can be incorporated into the body of a wrench by forming a lockable swivel joint between a tool head and the body of the wrench. A lockable swivel joint can be attached to either or both ends of the wrench. This allows the head of the swivel wrench to be positioned in various angular positions relative to the wrench body. In any of these embodiments the head of the wrench may be a fixed head, a pivoting head, or a ratcheting head, with open ended, closed end, box end, and other specialty heads. Similarly, the body of the wrench may be contoured, angled or straight. In addition, the wrench may have similar heads at each end or differing heads at each end. As a result, the present disclosure encompasses numerous variations of wrenches.

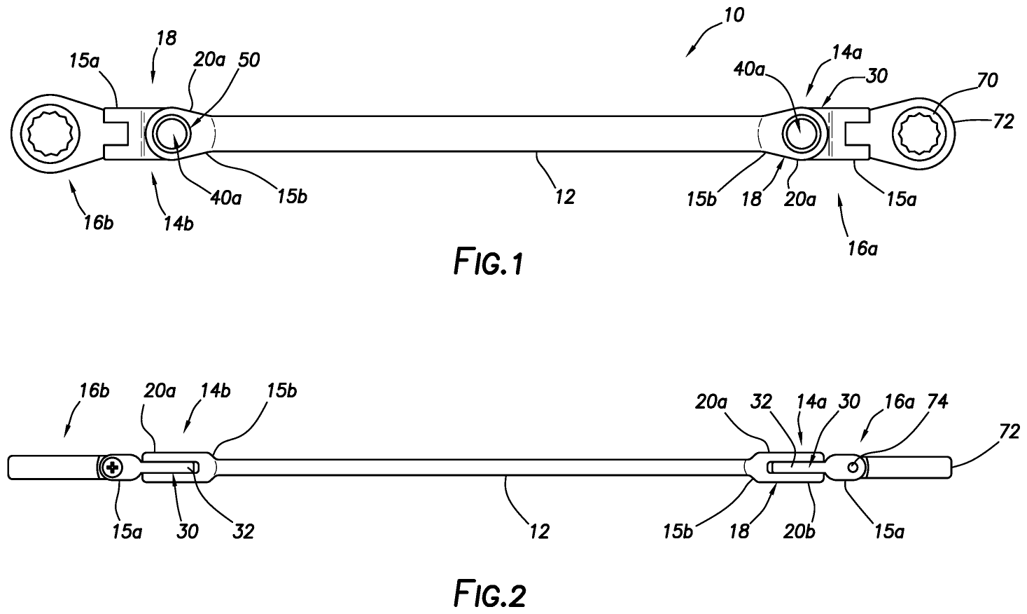

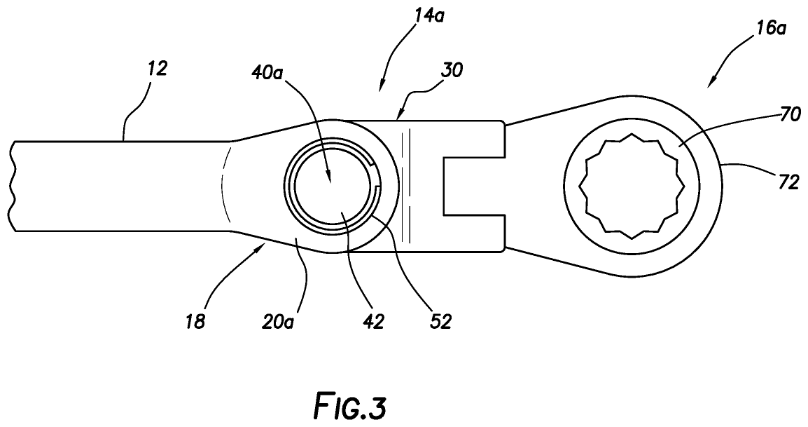

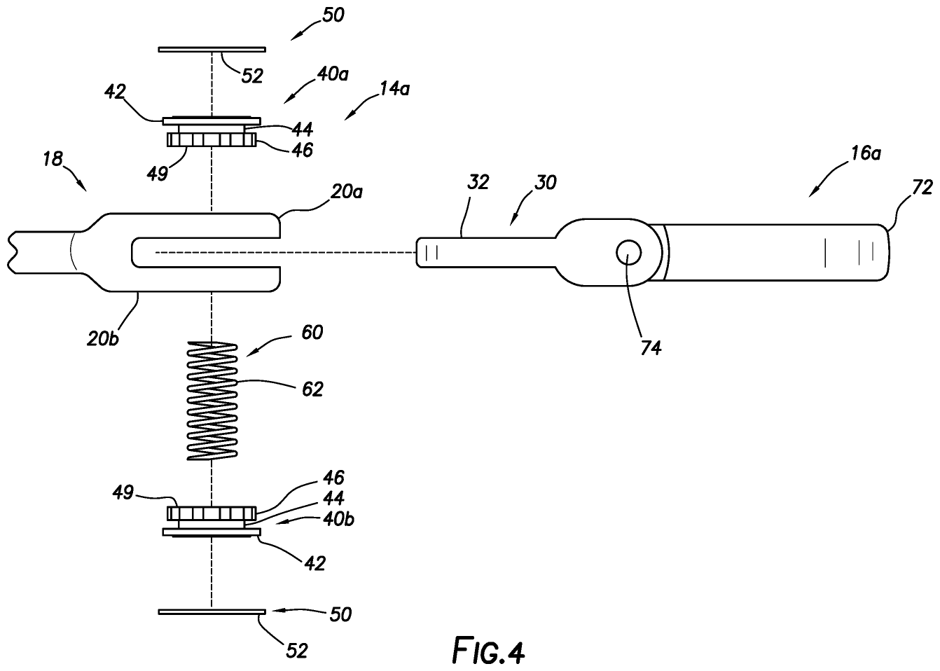

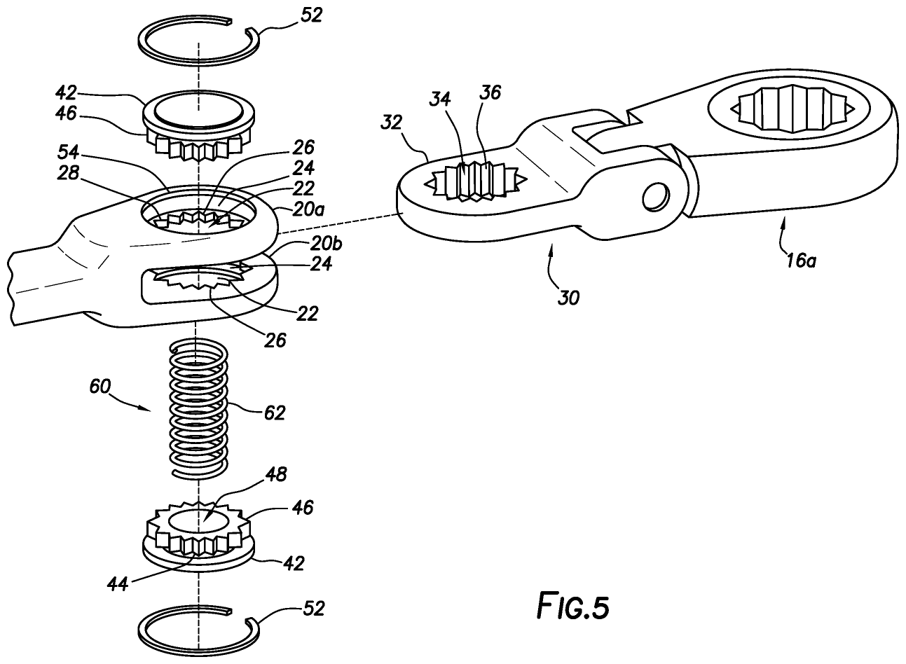

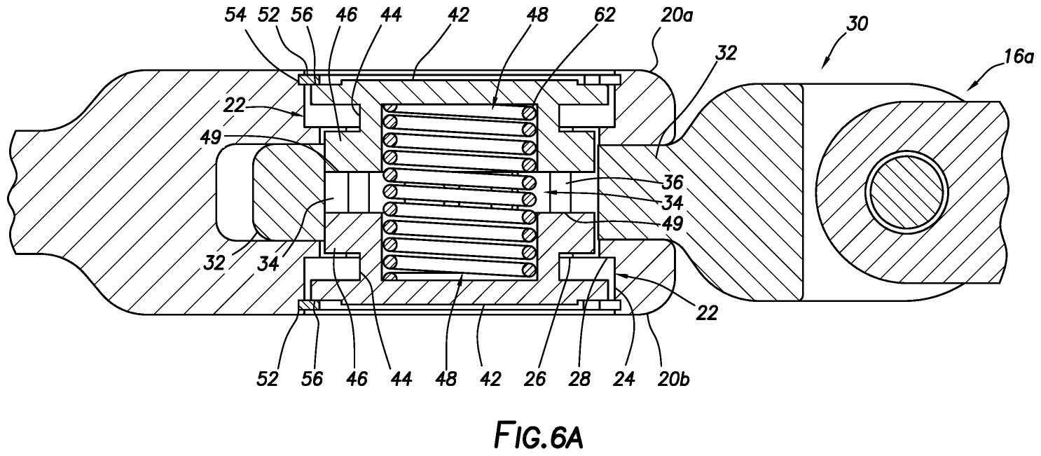

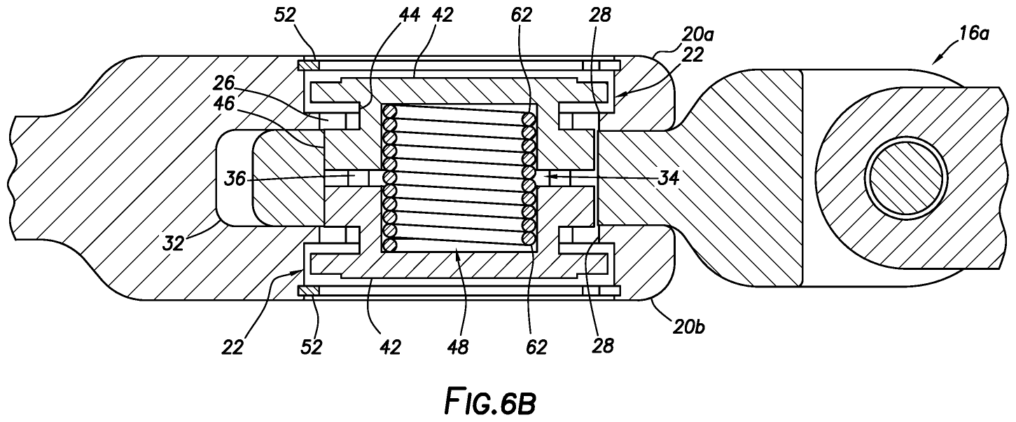

FIG. 1 is a top view of a hand-operated tool, namely a wrench, having two swivel joint adapters on opposing ends of the wrench in accordance with aspects of the present disclosure. FIG. 2 is an elevational view of the hand-operated tool of FIG. 1, namely a wrench, having two swivel joint adapters on opposing ends of the wrench in accordance with aspects of the present disclosure. FIG. 3 is a detail view of a swivel joint adapter and ratchet head of the wrench of FIGS. 1-2. FIG. 4 is an exploded, detail view of a swivel joint adapter of FIGS. 1-3. FIG. 5 is an orthogonal view of a swivel joint adapter of FIGS. 1-4. FIG. 6A is a cross-sectional view of a swivel joint according to aspects of the disclosure shown in a home or first position. FIG. 6B is a cross-sectional view of the swivel joint seen in FIG. 6A shown in a depressed or second position. The figures will be discussed together.

A hand-operated tool 10 is presented having a tool body 12, here a tool handle or shaft. Swivel joint adapters 14a-b are attached to the tool body 12, in this case at opposing ends of the tool body. Attached to each swivel joint adapter 14 is a tool head 16a-b. In the embodiment shown, the tool heads are pivoting, ratcheting wrench heads.

In alternate embodiments, the swivel joint adapters 14 can interconnect a tool body 10 with additional tool bodies. In such an embodiment, the swivel joint adapters create a daisy-chain of tool bodies 10 which can be selectively swiveled to various angular positions with respect to one another.

In other alternative embodiments, one or both of the pivoting, ratcheting wrench heads 16 can instead be other tool heads. For example, the swivel joint adapter can attach to a non-pivoting (fixed) tool head, pivoting tool head, ratcheting tool head, an open-ended, closed-end, box-end, and other shaped head, a wrench head, a ratchet head, a socket driver head, a fastener driver head, a pry bar or claw head, or other specialty tool heads.

The swivel joint adapter 14a comprises a first end 18 defining opposing forked arms 20a-b. Each arm 20 defines a lateral aperture 22 extending therethrough. The aperture 22 defines or is defined by a smooth-walled cylindrical portion 24 and a toothed-wall portion 26, as best seen in FIG. 5. In an embodiment, an annular shoulder 28 is defined between the smooth-walled portion 24 and toothed-wall portion 26. The lateral surfaces of the teeth of the toothed-wall portion 26 of the aperture 22 can define all or part of the shoulder 28.

The swivel joint adapter further comprises a second end 30 defining a tongue 32 which is positioned between the opposed forked arms 20. The tongue 32 has a lateral aperture 34 which is aligned with the apertures 22 of the forked arms 20. The tongue aperture 34 defines a toothed-wall 36 along at least a portion of its height. The toothed wall 36 of the tongue is similar to the toothed-wall portion 26 of each of the arms 20 allowing the teeth of the tongue and arms to align vertically. In one embodiment, the interior diameter defined by the tips of the teeth of the toothed-wall of the tongue aperture is smaller than the interior diameter defined by the tips of the teeth of the toothed-wall portion of the forked arms.

The swivel joint further comprises first and second opposed and depressible buttons 40a-b. Each button 40 is positioned in or extends through an aperture 22 of one of the opposed arms Each button has a head 42, preferably of enlarged diameter. Each button comprises a smooth-walled cylindrical portion 44 and a toothed-wall portion 46. The smooth-walled portion 44 has a relatively smaller diameter than the larger diameter of the toothed-wall portion 46, where the toothed-wall diameter is taken at the generally circular perimeter defined by connecting the tips of each of the teeth in a common plane. Preferably the head has a larger diameter than either the smooth-walled or toothed-wall portions of the button. Each button has a lower surface 49.

For each button 40, the toothed-wall portion 46 meshes with the toothed-wall portion 26 of the arm aperture 22 and the toothed-wall portion 36 of the tongue aperture 34. Each button is free to laterally and slidingly move with respect to the arm 20 and tongue 32 upon depression of the button by a user as best seen in FIGS. 6A-B. Similarly, the buttons are free to laterally slide in relation to the arm and tongue in response to a biasing means as described below.

Each button 40 is maintained on the swivel joint adapter by a retaining means 50, such as a retaining ring, split ring, snap ring, snap washer, or other retaining means known in the art. In the embodiment shown, the retaining means comprises a retaining ring 52 and corresponding groove 54 defined in the aperture wall of the arm 20. The retaining ring 52 fits into the circular groove 54 and is held in place by the spring force of the ring against the groove. The retaining ring 52, when in position in the groove 54, defines an annular shoulder 56 against which the button head 42 is biased.

The swivel joint adapter further comprises a biasing means 60. The biasing means 60 can be one or more coil springs, as shown, linear springs, leaf springs, torsion springs, Belleville washers, or other biasing devices as is known in the art, or a combination of one or more of any of these. The biasing means 60 shown is a coil spring 62 which seats at either end against an interior surface of an opposing button 40. In the embodiment shown, the ends of the spring each seat on interior surfaces of the buttons defined by or in a well 48 formed therein.

In use, each button is slidingly movable between a first or home position, as seen in FIG. 6A, and a second or depressed position, as seen in FIG. 6B. Each button 40 is prevented from disengaging from the swivel joint adapter by a retaining means 60, in this case retaining ring 62 whose shoulder 56 acts against the button head 42. The buttons can be removed by disengaging and removing the retaining ring as is known in the art. The buttons 40a-b remain in their first positions by action of the biasing means 60 which biases the buttons laterally away from one another and towards the first positions. Although a single coil spring is shown acting as the biasing means for both buttons, the biasing means can alternately comprise multiple biasing mechanisms.

In the first position, the toothed-wall portion 46 of the button 40 engages both the toothed-wall portion 26 of a forked arm aperture 22 and the toothed-wall 36 of the tongue aperture 34. The teeth of the button mesh with the teeth of the arm and tongue, preventing relative motion between the button, arm and tongue, and therefore preventing relative motion between the first and second ends of the swivel joint adapter.

In the second position, wherein the buttons 40a-b are both slidingly moved to their respective depressed positions, as seen in FIG. 6B, the toothed-wall portion 46 of the button 40 engages only the toothed-wall 36 of the tongue aperture 34. That is, in the depressed position, the toothed-wall portion 46 of the button 40 does not engage the toothed-walls 26 of the arm apertures 22. Thus, relative rotational motion is allowed between the forked arms 20 and the tongue 32, and therefore between the first and second ends of the swivel joint adapter. Such relative motion is allowed only where both buttons are in their second positions.

When the buttons are in the depressed position, the smooth-walled portions 44 of the buttons 40 are laterally aligned with the toothed-wall portions 26 of the arm apertures 22. The smooth-walled portions 44 of the buttons, when in the second position, do not engage the toothed-walls 26 of the arm apertures 22, allowing relative motion therebetween.

Inward lateral movement of a button 40 can be limited by, for example, the shoulder 28 defined on the arm aperture 22. Alternately, lateral movement of the buttons 40 can be limited by contact occurring between the buttons themselves, such as the bottom surfaces 49 abutting one another. Alternately, movement of the buttons can be limited by a shoulder defined on the tongue. Alternately, movement of the buttons can be limited by the biasing means, such as where the buttons can be moved toward one another until the biasing means reaches its limit of travel, such as a t full compression of the coil spring.

During movement of the buttons from the first to the second position, the toothed walls of the buttons move slidingly in relation to the toothed walls of the forked arms and tongue. The biasing spring 62 is compressed by depression of the opposing buttons 40a-b. Upon release of the buttons 40, the biasing spring 62 forces the buttons 40 to their respective first positions. The toothed-walls 46 of the buttons 40 re-engage the toothed-walls 26 of the arm apertures 22 and the swivel joint adapter is locked such that relative motion is prevented between the tongue and arms. Thus, when one or both of the buttons 40 are in their home positions, the swivel joint is locked. To unlock the swivel joint adapter, both buttons 40 must be depressed.

This arrangement serves as a safety feature. In swivel joints requiring only a single button, the button is prone to being accidently engaged by the user during normal use of the hand-operated tool, thereby unlocking the swivel joint during use. Accidental unlocking can result in injury, dropping of the tool, etc. Accidental unlocking and swivelling is unlikely in the disclosed embodiments which require positive action of both opposed buttons to unlock the swivel joint.

With both buttons depressed, the user can move the ends of the swivel joint (and their attachments) relative to one another to a selected relative angular position. The ends are locked into the selected relative angular positions upon release of the buttons as the toothed wall of the button re-engages the toothed wall of the forked arm.

The specific locations of the angular positions are defined by the spacing of the teeth of the toothed walls of the buttons, arms and tongue. The swivel joint adapter provides a swivel motion about a swivel axis and preferably allows swivelling through an arc of 180 degrees. In alternate embodiments, greater or lesser arcs of movement are provided. In a preferred embodiment, the toothed walls comprise 16 teeth.

Each swivel joint adapter further comprises two free ends 15. In the embodiment seen in FIGS. 1-6, one free end 15 is connected to a tool head 16 and more specifically a pivoting, ratcheting wrench head. The other free ends 15 of the swivel joint adapters 14 are attached to a tool body or shaft 12.

As mentioned above, the pivoting ratchet wrench heads 16 are exemplary. The pivoting heads 16 each comprise a ratchet ring 70 mounted for rotary movement within a wrench perimeter wall 72, and a pivoting joint 74 with a pivot pin 76. The head 16 is attached to the second (tongue) end 30 of the swivel joint adapter 14 by a clevis or U-shaped connector within which another part can be fastened by a bolt or pin passing through the ends of the connector. In the embodiment shown, one of the pivoting arms of the wrench head and the second end of the swivel joint adapter are of-a-piece or monolithic. In alternate embodiments, the tool head 16 is a separate piece and attached via attachments as are known in the art.

In the embodiment of the hand-operated tool 10 as shown, the tool shaft 12 is monolithically formed with the first ends 18 of the swivel joint adapters 14a-b. In alternate embodiments, the first ends can be attached to the tool shaft by any suitable attachment known in the art.

Further, the swivel joint adapters are shown having their forked arms 20 on the “tool” side of the joint and their tongues 32 on the “tool head” side of the joint. This arrangement can be reversed in other embodiments.

The toothed wall and smooth walled portions of the apertures of the buttons, arms and tongue can each be considered cylinders or cylindrical walls and each has a defining diameter. For the toothed walls, the diameter is considered to be the diameter of the circle described by connecting each tip of each tooth to the tips of the adjacent teeth. Alternately, the diameter can be considered at mid-tooth height, etc. For the arms and buttons, which have in some embodiments both toothed wall cylinders and smooth walled cylinders, the cylinders are concentric or axially aligned. The toothed walled cylinder of a button has a diameter larger than that of the smooth walled cylinder of the button, and thus can be considered to have a relatively enlarged diameter. Similarly for the arms, the toothed walled cylinder has a smaller or reduced diameter relative to the diameter of the smooth walled cylinder of the arms.

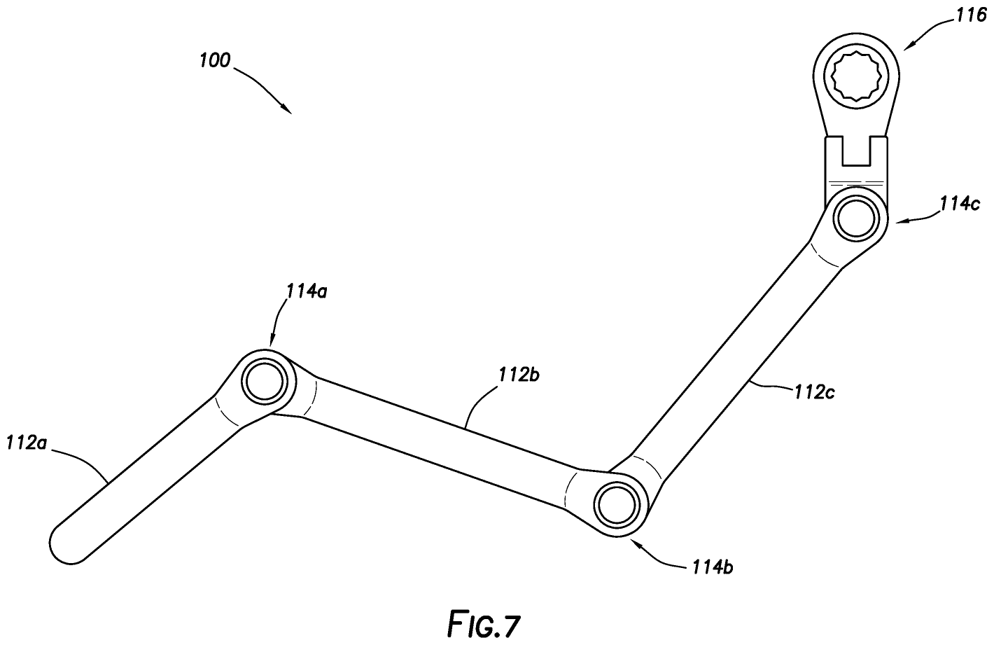

FIG. 7 is a schematic top view of a hand-operated tool having multiple swivel joint adapters according to aspects of the disclosure. Here, multiple swivel joint adapters 114a-b are used to interconnect a plurality of tool bodies 112a-c in a single tool 100. The swivel joint adapter 114c interconnects a tool body 112c and a tool head 116. The tool head is shown as a pivoting socket driver but can obviously take the form of any suitable tool head. In such an embodiment, the swivel joint adapters 114 create a daisy-chain of tool bodies 112 which can be selectively swiveled to various angular positions with respect to one another. As described above herein, the double-button swivel release prevents accidental release of any swivel joint adapter during use.

Disclosed herein are (1) a swivel joint adapter for a handheld tool comprising: a first end defining spaced-apart arms, each arm having a lateral aperture extending therethrough, each aperture having a toothed-wall portion; a second end defining a tongue positioned between the spaced-apart arms and defining a lateral aperture extending therethrough aligned with the arm apertures, the tongue aperture having a toothed-wall; first and second buttons positioned on the opposed spaced-apart arms, each button comprising a head for depression by a user, the head connected to a cylinder having a reduced diameter portion and an enlarged diameter portion, the enlarged diameter portion having a toothed-wall; wherein each button is movable between: a first position, wherein the toothed-wall of the button engages the toothed-wall portion of an arm aperture and the toothed-wall of the tongue aperture, and a second position wherein the toothed-wall of the button engages only the toothed-wall of the tongue aperture, wherein relative rotational movement between the arms and the tongue is prevented by the engaged toothed-walls unless both buttons are in their second positions. Also presented is (2), the swivel joint adapter of (1) wherein each button is biased towards its first position by a biasing means. Also presented is (3), the swivel joint adapter of (2), wherein the biasing means is taken from the group consisting of: coil springs, linear springs, leaf springs, torsion springs, Belleville washers, and any combination thereof. Also presented is (4), the swivel joint adapter of (2), wherein sliding travel of the buttons to their respective second positions is limited by the buttons abutting one another, the buttons abutting shoulders defined on the arms or tongue, or by operation of the biasing means. Also presented is (5), the swivel joint adapter of (1), wherein each arm aperture further defines an enlarged diameter portion allowing for lateral travel of a button head. Also presented is (6), the swivel joint adapter of (1), wherein, for each of the opposed buttons, the reduced diameter portion of the button cylinder aligns laterally with the toothed wall portion of a respective arm when the button is in the second position. Also presented is (7), the swivel joint adapter of (1), wherein, for each button, the reduced diameter portion of the button cylinder is smooth-walled. Also presented is (8), the swivel joint adapter of (1), wherein each button is retained by a retaining means selected from the group consisting of: a retaining ring, a snap ring, a split ring, and a split washer. Also presented is (9, the swivel joint adapter of (1), wherein the swivel joint adapter is attached to at least one tool head. Also presented is (10), the swivel joint adapter of (1), wherein the swivel joint adapter is attached to at least one tool body. Also presented is (11), the swivel joint adapter of (1), wherein the first end of the swivel joint adapter is connected to either a tool head or a tool body, and wherein the second end of the swivel joint adapter is connected to either a tool head or a tool body.

Disclosed herein are (12) a hand-operated tool having a swivelling joint adapter, the hand-operated tool comprising: an elongated tool body having opposing ends, one end of the tool body defining forked arms, each forked arm having a lateral aperture extending therethrough, each aperture having a reduced diameter portion defining a toothed-walled cylinder and an expanded diameter portion defining a smooth-walled cylinder; a tool head having a tongue positioned between the forked arms, the tongue having a lateral aperture extending therethrough and aligned with the apertures of the forked arms, the tongue aperture defining a toothed wall cylinder; opposed first and second buttons positioned on the opposed forked arms, each button comprising a button head for depression by a user and a toothed-wall cylinder sized to slidingly engage the toothed-wall cylinders of the forked arm and tongue apertures; wherein each button is movable between a first position, wherein the button's toothed wall cylinder engages the toothed wall of an arm aperture and the toothed wall of the tongue aperture, and a second position wherein the toothed cylinder engages only the toothed wall of the tongue aperture, wherein relative rotational movement between the forked arms and the tongue is prevented by the engaged toothed wall cylinders unless both buttons are in their second positions; and each button biased towards the first position. Also presented is (13), the hand tool of (12), each button retrained in its respective arm by a retaining means. Also presented is (14), the hand tools of (12), further comprising a retaining ring for each button, each retaining ring positioned in a circumferential groove defined on an arm aperture. Also presented is (15), the hand tool of (12), wherein each button is biased towards the first position by a biasing means. Also presented is (16), the hand tool of (15), wherein the biasing means is a biasing spring having opposing ends, each spring end seated against a seat defined on the opposing buttons. Also presented is (17), the hand tool of (12), wherein the tool head is a wrench head, a socket head, a socket driver head, a ratcheting head, a fixed head, an open ended head, a closed end head, a box end head, or a hinged head. Also presented is (18), the hand tool of (12), each of the buttons further comprising a reduced diameter smooth walled cylinder, concentric with and adjacent to the toothed wall cylinder, and wherein the smooth walled cylinder is aligned with the toothed wall cylinder of the tongue aperture when the button is in the second position. Also presented is (19), the hand tool of (12), wherein each forked arm further comprises an annular shoulder defined between the toothed-walled and smooth-walled cylinders of the arm aperture, the annular shoulder for limiting sliding movement of the button positioned on the arm.

Also disclosed is (20) a hand tool having multiple swivel joints, the hand tool comprising: a plurality of elongated tool bodies, each tool body having opposed ends; a plurality of swivel joints interposed between and connecting adjacent ends of the plurality of tool bodies, each swivel joint comprising: a forked arm end of a first tool body having spaced-apart first and a second arms, each arm having a lateral aperture extending therethrough, each aperture defined by a reduced diameter, smooth walled cylinder and an enlarged diameter, toothed walled cylinder; a tongue end of a second tool body having a tongue, the tongue positioned between the forked arms and having a lateral aperture aligned with those of the forked arms, the tongue aperture defined by a toothed wall cylinder; opposed first and second buttons positioned on the first and second forked arms, respectively, each button comprising a button head for depression by a user, an enlarged diameter, toothed wall cylinder and a reduced diameter, smooth walled cylinder; wherein each button is movable between a first position, wherein the toothed wall cylinder of the button engages the toothed wall cylinder its respective forked arm and the toothed wall of the tongue, and a second position wherein the toothed wall cylinder of the button engages only the toothed wall of the tongue, and wherein relative rotational movement between the forked arms and the tongue is prevented by the engaged toothed walls unless both buttons are in their second positions; each button biased towards the first position; and a tool head connected to at least one of the ends of the connected plurality of tool bodies. Also presented is (21) the hand tool of (20), the tool head connected to a tool body by a hinged joint. Also presented is (22), the hand tool of (21), the tool head attached to the tool body by a swivel joint. Also presented is (23), the hand tool of (20), wherein the tool head is a wrench head, a socket head, a ratcheting head, a fixed head, an open ended head, a closed end head, a box end head, or a hinged head. Also presented is (24), the hand tool of (20), wherein, for at least one of the plurality of tool bodies, one end of the body is a forked arm end and the other end of the tool body is a tongue end. Also presented is (25), the hand tool of (20), wherein, for at least one of the plurality of tool bodies, both ends of the tool body are either forked arm ends or tongue ends of a swivel joint. Also presented is (26), the hand tool of (20), wherein travel of the buttons to their respective second positions is limited by the buttons abutting one another, the buttons abutting shoulders defined on the arms or tongue, or by operation of a biasing means.

While this disclosure has been described in reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

It will be understood that particular embodiments described herein are shown by way of illustration and not as limitations of the disclosure. The principal features of this disclosure can be employed in various embodiments without departing from the scope of the disclosure. Those skilled in the art will recognize, or be able to ascertain using no more than routine experimentation, numerous equivalents to the specific procedures described herein. Such equivalents are considered to be within the scope of this disclosure and are covered by the claims.

Terms such as “a” and “an” and “the” are not intended to refer to only a singular entity, but include the general class of which a specific example may be used for illustration. The terminology herein is used to describe specific embodiments of the disclosure, but their usage does not delimit the disclosure.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” and any form of comprising, such as “comprise” and “comprises”, “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and/or methods and in the steps or in the sequence of steps of the method described herein without departing from the concept, spirit and scope of the disclosure. All such similar substitutes and modifications apparent to those skilled in the art are deemed to be within the spirit, scope and concept of the disclosure as defined by the appended claims.

What is claimed is:

1. A hand-operated tool having a swiveling joint adapter, the hand-operated tool comprising:
an elongated tool body having opposing ends, one end of the tool body defining forked arms, each forked arm having a lateral aperture extending therethrough, each aperture having a reduced diameter portion defining a toothed-walled cylinder and an enlarged diameter portion generally defining a cylinder;
a tool head having a tongue positioned between the forked arms, the tongue having a lateral aperture extending therethrough and aligned with the apertures of the forked arms, the tongue aperture defining a toothed wall cylinder;
opposed first and second buttons positioned on the opposed forked arms, each button comprising a button head for depression by a user and a toothed-wall cylinder sized to slidingly engage the toothed-wall cylinders of the forked arm and tongue apertures;
wherein each button is movable between a first position, wherein the button's toothed wall cylinder engages the toothed-wall cylinder of an arm aperture and the toothed-wall cylinder of the tongue aperture, and a second position wherein the toothed-wall cylinder engages only the toothed-wall cylinder of the tongue aperture, and
wherein relative rotational movement between the forked arms and the tongue is prevented by the engaged toothed-wall cylinders unless both buttons are in their second positions; and
each button biased towards the first position, each button retained by contact between the button head and a retaining means positioned on a forked arm for that purpose.

2. The hand-operated tool of claim 1, wherein the retaining means comprise a retaining ring, each retaining ring positioned in a circumferential groove defined on an arm aperture.

3. The hand-operated tool of claim 1, wherein each button is biased towards the first position by a biasing means, and wherein each button is biased into contact with its respective retaining means.

4. The hand-operated tool of claim 3, wherein the biasing means is a biasing spring having opposing ends, each spring end seated against a seat defined on the opposing buttons.

5. The hand-operated tool of claim 1, each of the buttons further comprising a reduced diameter smooth walled cylinder, concentric with and adjacent to the toothed wall cylinder of the button, and wherein the smooth walled cylinder is aligned with the toothed wall cylinder of the tongue aperture when the button is in the second position.

6. The hand-operated tool of claim 1, wherein each forked arm further comprises an annular shoulder defined between the toothed-walled and smooth-walled cylinders of the arm aperture, the annular shoulder for limiting sliding movement of the button positioned on the arm.

7. A hand tool having multiple swivel joints, the hand tool comprising:
a plurality of elongated tool bodies, each tool body having opposed ends;
a plurality of swivel joints interposed between and connecting adjacent ends of the plurality of tool bodies, each swivel joint comprising:
a forked arm end of a first tool body having spaced-apart first and a second arms, each arm having a lateral aperture extending therethrough, each aperture defined by an enlarged diameter, smooth walled cylinder and a reduced diameter, toothed walled cylinder;
a tongue end of a second tool body having a tongue, the tongue positioned between the forked arms and having a lateral aperture aligned with those of the forked arms, the tongue aperture defined by a toothed wall cylinder;
opposed first and second buttons positioned on the first and second forked arms, respectively, each button comprising a button head for depression by a user, an enlarged diameter, toothed wall cylinder and a reduced diameter, smooth walled cylinder;
wherein each button is movable between a first position, wherein the toothed wall cylinder of each button engages the toothed wall cylinder of its respective forked arm and the toothed wall cylinder of the tongue, and a second position wherein the toothed wall cylinder of each button engages only the toothed wall cylinder of the tongue, and
wherein relative rotational movement between the forked arms and the tongue is prevented by the engaged toothed walls unless both buttons are in their second positions;
each button biased towards the first position; and
a tool head connected to one end of one of the plurality of tool bodies by a head-to-body swivel joint having a swivel axis, the tool head comprising a hinged joint having a hinge axis perpendicular to a swivel axis of the nearest swivel joint.

8. The hand tool of claim 7, wherein the tool head is a wrench head, a socket head, a ratcheting head, a fixed head, an open-ended head, a closed end head, a box end head, or a hinged head.

9. The hand tool of claim 7, wherein travel of the buttons to their respective second positions is limited by the buttons abutting one another, the buttons abutting shoulders defined on the arms or tongue, or by operation of a biasing means.

10. A swivel joint adapter for a handheld tool comprising:
a first end defining spaced-apart arms, each arm having a lateral aperture extending therethrough, each aperture having a toothed-wall portion;
a second end defining a tongue positioned between the spaced-apart arms and defining a lateral aperture extending therethrough aligned with the arm apertures, the tongue aperture having a toothed-wall;
first and second buttons positioned on the opposed spaced-apart arms, each button comprising a head for depression by a user, and a generally cylindrical toothed-wall portion;
wherein each button is movable between: a first position, wherein the toothed-wall portion of the button engages the toothed-wall portion of an arm aperture and the toothed-wall of the tongue aperture, and a second position wherein the toothed-wall portion of the button engages only the toothed-wall of the tongue aperture, and wherein relative rotational movement between the arms and the tongue is prevented by the engaged toothed-walls unless both buttons are in their second positions; and
wherein each button is biased towards the first position by a biasing means, and wherein travel of the buttons to their respective second positions is limited by the biasing means.

11. The swivel joint adapter of claim 10, further comprising, for each button, a reduced diameter portion between the head and toothed-wall portion of the button, the reduced diameter portion having a diameter smaller than that of both the head and the tooth-walled portion.

12. The swivel joint adapter of claim 10, further comprising, for each button, a retaining means for acting on the head of the button to retain the button in the aperture of its respective spaced-apart arm.

13. The swivel joint adapter of claim 10, wherein the biasing means biases the head of each button biased into contact with its respective retaining means.
